(19) United States
(12) Patent Application Publication
(10) Pub. No.: US 2019/0335115 A1
(43) Pub. Date: Oct. 31, 2019

(54) DISPLAY CONTROL DEVICE, HEAD-MOUNTED DISPLAY, AND CONTROL PROGRAM

(71) Applicant: SHARP KABUSHIKI KAISHA, Sakai City, Osaka (JP)

(72) Inventor: HISAO KUMAI, Sakai City, Osaka (JP)

(73) Assignee: SHARP KABUSHIKI KAISHA, Sakai City, Osaka (JP)

(21) Appl. No.: 16/463,831

(22) PCT Filed: Nov. 28, 2017
(86) PCT No.: PCT/JP2017/042491

§ 371 Date: May 23, 2019

(30) Foreign Application Priority Data
Nov. 29, 2016 (JP) 2016-231676

(51) Int. Cl. H04N 5/272; H04N 5/232; G06F 3/01; H04N 5/445; H04N 5/45

(52) U.S. Cl. CPC H04N 5/272; H04N 5/23238; H04N 5/45; H04N 5/44504; G06F 3/013

(57) ABSTRACT

Provided is an improvement in display content in a superimposition display technique. A display device includes: an omnidirectional image rendering unit configured to identify a display-target region; and a combining unit configured to cause a superimposable image to be displayed as being superimposed over a partial image, the superimposable image being obtained by capturing at least a part of an imaging target by use of a different imaging device from an imaging device used for capturing a captured image.

### TECHNICAL FIELD

An aspect of the disclosure relates to, among other things, a display control device configured to display a partial image of a specified display-target region in an image region, then to superimpose an image over the partial image, and then to display the resultant image.

### BACKGROUND ART

PTL 1 discloses a technology related to the delivery of panoramic videos. In addition, PTL 2 discloses a technology related to the display of an omnidirectional image. Each of these documents relates to a technique for causing a display device to display a partial image of a specified display-target region of an image, such as an omnidirectional image, having an image region of a size that does not fall within one screen of the display device.

### CITATION LIST

### Patent Literature

PTL 1: JP 2015-173424 A (published on Oct. 1, 2015)

PTL 2: JP 2015-18296 A (published on Jan. 29, 2015)

### SUMMARY

### Technical Problem

In a technique such as one described above, it is preferable that multifaceted information be provided to and recognized by the user by allowing an additional image to be superimposed over a pre-displayed partial image extracted from an image region and specified as a display-target region. However, there is still some room for improvement in the technique such as one described above.

For example, PTL 2 describes that a thumbnail of a partial image is displayed at a prescribed location in an image of a view list. Thumbnails are, however, only reduced versions of the corresponding partial images, and thus do not include any more information than that included in the corresponding partial images. Hence, the user is not able to obtain any more information from the screen displaying a thumbnail than that obtained directly from the corresponding partial image itself. In addition, a superimposed thumbnail may prevent the user from viewing the corresponding partial image itself. However, none of PTLs 1 and 2 is able to recognize; that there are problems like the ones described above, and thus any of PTLs 1 and 2 provides a solution to such problems.

Hence, an aspect of the disclosure provides a display control device or the like capable of improving the content to be displayed by a technique where an additional image is superimposed over a pre-displayed partial image extracted from an image region and specified as a display-target region.

### Solution to Problem

To solve the problems described above, an aspect of the disclosure provides a display control device that causes a display device to display a partial image of a specified display-target region within an image region of a captured image obtained by capturing an imaging target. The display control device includes: a region identifying unit configured to identify the display-target region; and a superimposing unit configured to cause a superimposable image to be displayed as being superimposed over the partial image, the superimposable image being obtained by capturing at least a part of the imaging target by use of a different imaging device from an imaging device used for capturing the captured image.

To solve the problems described above, an aspect of the disclosure provides a display control device that causes a display device to display a partial image of a specified display-target region within an image region of a captured image obtained by capturing an imaging target. The display control device includes: a region identifying unit configured to identify the display-target region; and a superimposing unit configured to cause an image to be displayed as being superimposed over the partial image, the image being obtained by capturing at least a part of the imaging target and having a higher resolution than the captured image.

To solve the problems described above, an aspect of the disclosure provides a display control device that causes a display device to display a partial image of a specified display-target region within an image region of a captured image obtained by capturing an imaging target. The display control device includes: a position determining unit configured to determine, in accordance with a content of the partial image, a superimposing position of a superimposable image to be displayed as being superimposed over the partial image; and a superimposing unit configured to cause the superimposable image to be displayed as being superimposed at the superimposing position determined by the position determining unit.

To solve the problems described above, an aspect of the disclosure provides a control method for a display control device that causes a display device to display a partial image of a specified display-target region within an image region of a captured image obtained by capturing an imaging target. The method includes the steps of: identifying the display-target region; and superimposing, to be displayed over the partial image, a superimposable image obtained by capturing at least a part of the imaging target by use of a different imaging device from an imaging device used for capturing the captured image.

### Advantage Effects of Invention

An aspect of the disclosure has an effect of achieving an improved content to be displayed by a technique where an additional image is superimposed over a pre-displayed partial image extracted from an image region and specified as a display-target region.

### BRIEF DESCRIPTION OF DRAWINGS

FIG. 1 is a block diagram illustrating an exemplar main-portion configuration of a display device according to Embodiment 1 of the disclosure.

FIG. 2 is a diagram illustrating a relationship between an omnidirectional image and a display-target region.

FIG. 3 is a diagram illustrating an image to be displayed by the display device according to Embodiment 1 of the disclosure.

FIGS. 4A and 4B are diagrams illustrating exemplar pieces of superimposable-image management information stored in a storage unit of the display device according to Embodiment 1 of the disclosure.

FIG. 5 is a flowchart describing an exemplar processing to be performed to cause the display device according to Embodiment 1 of the disclosure to display an image.

FIG. 6 is a diagram illustrating an exemplar piece of superimposable-image management information stored in a storage unit of the display device according to Embodiment 2 of the disclosure.

FIGS. 7A and 7B are diagrams illustrating exemplar pieces of information indicating superimposition-prohibited regions according to Embodiment 2 of the disclosure.

FIG. 8 is a flowchart describing an exemplar processing to be performed to cause the display device according to Embodiment 2 of the disclosure to display an image.

FIG. 9 is a diagram illustrating an image to be displayed by the display device according to Embodiment 3 of the disclosure.

FIG. 10 is a diagram illustrating an exemplar piece of information indicating a superimposition-prohibited region according to Embodiment 3 of the disclosure.

FIGS. 11A and 11B are diagrams illustrating exemplar pieces of information indicating a detection target according to Embodiment 3 of the disclosure.

FIG. 12 is a flowchart describing an exemplar processing to be performed to cause the display device according to Embodiment 3 of the disclosure to display an image.

FIG. 13 is a block diagram illustrating an exemplar main-portion configuration of a display control system according Embodiment 4 of the disclosure.

### DESCRIPTION OF EMBODIMENTS

### Embodiment 1

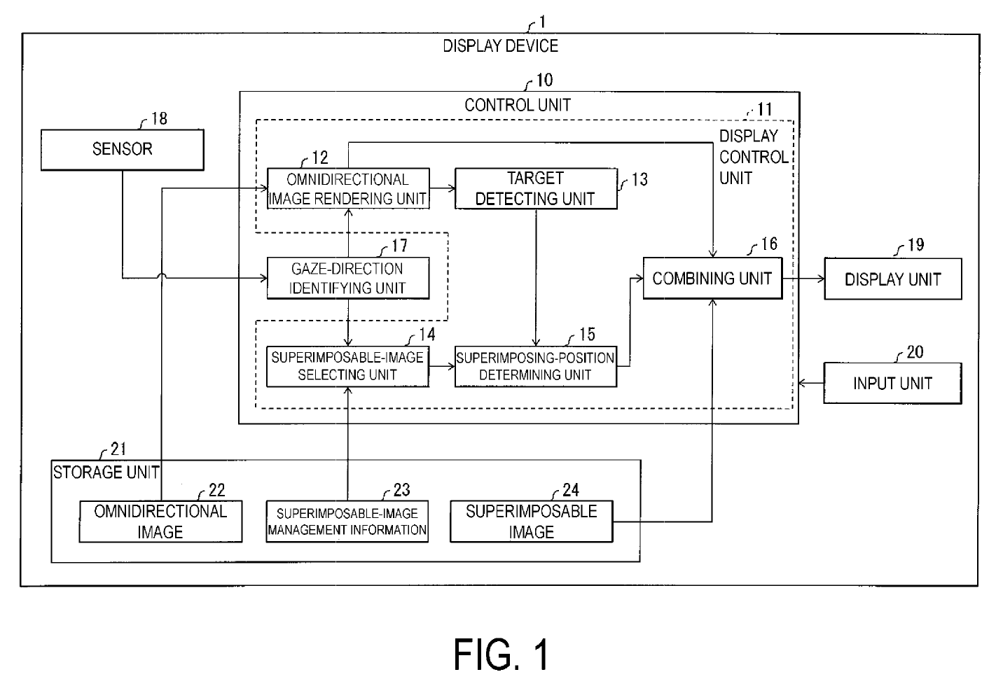

An embodiment of the disclosure will be described below with reference to FIG. 1 to FIG. 5.

### Device Configuration

FIG. 1 is a block diagram illustrating an exemplar main-portion configuration of a display device 1 according to the present embodiment. The display device 1 is a device configured to display contents. The description of the present embodiment is based on an example where the display device 1 is a head-mounted display (HMD) to be used by being mounted on the head of a user. Note that the display device 1 is not limited to an HMD, and may be a personal computer equipped with a display unit, a television receiver, a smart phone, a tablet terminal, or the like. The display device 1 includes a control unit 10, a sensor 18, a display unit 19, an input unit 20, and a storage 21.

The control unit 10 includes the following units, and is configured to perform overall control of such units of the display device 1: an omnidirectional image rendering unit (region identifying unit) 12, a target detecting unit (prohibited-object detecting unit, target detecting unit) 13, a superimposable-image selecting unit 14, a superimposing-position determining unit (prohibited-region identifying unit, position determining unit) 15, a combining unit (superimposing unit) 16, and a gaze-direction identifying unit 17. Of the above-mentioned units, the omnidirectional image rendering unit 12, the target detecting unit 13, the superimposable-image selecting unit 14, the superimposing-position determining unit 15, and the combining unit 16 together form a display control unit 11.

Based on the gaze direction identified by the gaze-direction identifying unit 17, the omnidirectional image rendering unit 12 identifies a display-target region in the omnidirectional image 22, Then, the omnidirectional image rendering unit 12 causes the display unit 19 to display, via the combining unit 16, a partial image of the display-target region identified as above from the image region of the omnidirectional image 22. To put it differently, the contents to be displayed by the display device 1 include the omnidirectional image 22. The omnidirectional image 22 may be a video or may be a still image.

The target detecting unit 13 is configured to detect, from the omnidirectional image 22, a superimposition-prohibited object, over which no superimposable object is allowed to be superimposed. Superimposable objects are objects that can be displayed in a state where the superimposable object is superimposed over the omnidirectional image 22. Details of the superimposable object will be described below.

The superimposable-image selecting unit 14 is configured to select a superimposable object. Specifically, the superimposable-image selecting unit 14 is configured to determine whether there is a superimposable object that is to be displayed over the display-target region identified by the omnidirectional image rendering unit 12. In a case where the superimposable-image selecting unit 14 determines that there is a superimposable object that is to be displayed, the superimposable-image selecting unit 14 selects the superimposable object as an object that is to be displayed in a state of being superimposed over the omnidirectional image 22.

Based on the contents of the partial image, the superimposing-position determining unit 15 is configured to determine the superimposing position where the superimposable object selected by the superimposable-image selecting unit 14 is to be superimposed. In addition, the superimposing-position determining unit 15 is configured to determine the display modes of the superimposable object.

The combining unit 16 causes the display unit 19 to display a display-target region of the omnidirectional image 22. In a case where the superimposable-image selecting unit 14 selects a superimposable object, the combining unit 16 makes the selected superimposable object be superimposed and thus displayed over the partial image of the omnidirectional image 22 at a position and in modes determined by the superimposing-position determining unit 15.

The gaze-direction identifying unit 17 is configured to determine the gaze direction of the user of the display device 1 based on the output value of the sensor 18. The sensor 18 is configured to detect the direction of the display device 1, i.e., the direction of the user wearing the display device 1 (i.e., the front direction of the user). The sensor 18 may be a six-axis sensor including a combination of at least two of the following sensors: a three-axis gyroscopic sensor; a three-axis acceleration sensor; and a three-axis magnetic field sensor; and the like. The gaze-direction identifying unit 17 is configured to identify, based on the output values of these sensors, the direction in which the user's face is facing, and then to define the identified direction of the user's face as the user's gaze direction. The sensor 18 may be one configured to detect the position of the iris of the user. In this case, the gaze-direction identifying unit 17 identifies the gaze direction based on the position of the user's iris. The sensor 18 may include a sensor configured to detect the direction of the user's face and a sensor configured detect the position of the iris of the user. Note that the identification of the gaze direction can be achieved by a configuration other than the ones described above. For example, a camera installed outside of the display device 1 may be used instead of the sensor 18. In this case, the display device 1 may be provided with a light emitting device, which is made to flicker. Images of the flickering of the light emitting device are captured by use of the above-mentioned camera. Based on the images thus captured, the position and the direction of the display device 1 may be detected. A possible alternative way of determining the gaze direction is as follows: providing an optical receptor in the display device 1 and a light emitting device outside of the display device 1; making the light emitting device emit a laser beam or the like and making the optical receiver receive the laser beam or the like; and calculating the gaze direction based on the measured light-receiving time, the angle measured at each light-receiving point, and the time lag between points.

The display unit 19 is a device (display device) configured to display an image. The display unit 19 may be non-transparent or may be transparent. In a case of using a transmissive display unit 19, a composite real space can be provided to the user. In the composite real space, an image displayed by the display unit 19 is superimposed over the view of the field outside of the display device 1 (i.e., the real space). The display unit 19 may be an external display device externally attached to the display device 1, or may be an ordinary flat panel display, or the like.

The input unit 20 is configured to accept input operations of the user and to output, to the control unit 10, information indicating the details of the accepted input operations. The input unit 20 may be, for example, a reception unit configured to receive, from an unillustrated controller, a signal indicating the details of the user's input operation into the controller.

The storage unit 21 is configured to store various kinds of data to be used by the display device 1. The storage unit 21 stores the omnidirectional image (captured image) 22, the superimposable-image management information 23, and an image to be superimposed (hereinafter, referred to as the “superimposable image”) 24. The omnidirectional image 22 is an image obtained by capturing images of all the directions from an imaging point. The superimposable-image management information 23 is information to be used for the control of the displaying of the superimposable object. The superimposable image 24 is an image that is displayed as being superimposed over the omnidirectional image 22.

Displaying Image in Accordance with Gaze Direction

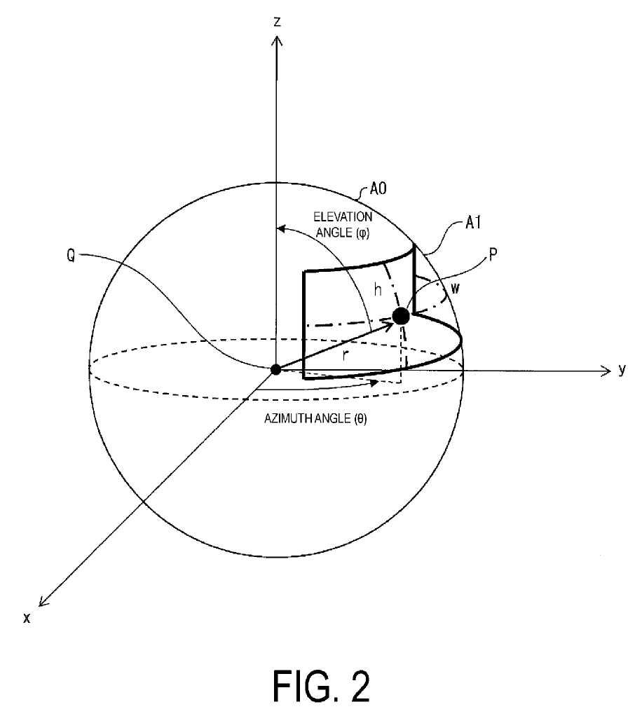

A method for displaying an image in accordance with the gaze direction will be described based on FIG. 2. FIG. 2 is a diagram illustrating a relationship between an omnidirectional image and a display-target region. In FIG. 2, an omnidirectional image A0 is shown on a three-dimensional coordinate space defined by x-, y-, and z-axes that are orthogonal to one another. The omnidirectional image A0 is an image of an entire celestial sphere, which is a spherical body having a center Q and a radius r. The center Q corresponds to an imaging point from which the omnidirectional image A0 is captured. The z-axis direction corresponds to the vertical direction in the real space, the y-axis direction corresponds to the front direction of the user in the real space, and the x-axis direction corresponds to the left-and-right direction of the user in the real space.

The gaze-direction identifying unit 17 is configured to determine, based on the output value of the sensor 18, in which direction the sensor 18 is facing. The sensor 18 is mounted in the display device 1 so as to face a prescribed direction. Hence, if the display device 1 is installed in the correct orientation, the direction of the sensor 18 can be considered as the user's gaze direction as long as the display device 1 is mounted so as to face the correct direction. Hence, the following description is based on an assumption that the direction in which the sensor 18 is facing is the user's gaze direction. The gaze-direction identifying unit 17 can express the gaze direction by a combination of the following angles: an azimuth angle (yaw) θ (−180°≤θ≤180°), which is the rotation angle about the vertical axis (i.e., the z-axis); and an elevation angle (pitch) φ (−90°≤φ≤90°), which is a rotation angle about the horizontal axis (i.e., the x-axis).

Once the gaze-direction identifying unit 17 has identified the azimuth angle and the elevation angle that indicate a gaze direction, the omnidirectional image rendering unit 12 determines the position of an intersection point P where the straight line extending from the center Q (i.e., the user's viewing position) in the direction indicated by the identified azimuth angle and the identified elevation angle intersects the omnidirectional image A0. Then, in the omnidirectional image A0, a region having a height h and a width w and centered on the intersection point p is identified as the display-target region A1. Then, the omnidirectional image rendering unit 12 causes the display unit 19 to display a partial image, which is an image showing a portion of the omnidirectional image A0, the portion corresponding to the display-target region A1. Hence, whenever the display-target region A1 changes in accordance with the changes in the user's gaze direction, the image displayed on the display unit 19 changes as well. Note that, in the present embodiment, for the sake of a simple explanation, the position of the viewpoint within the entire celestial sphere is assumed to be fixed at (not movable from) the center Q. It is, however, allowable, that the position of the viewpoint within the entire celestial sphere may be movable from the center Q in accordance with the movement of the user in the real space.

### Image to be Displayed

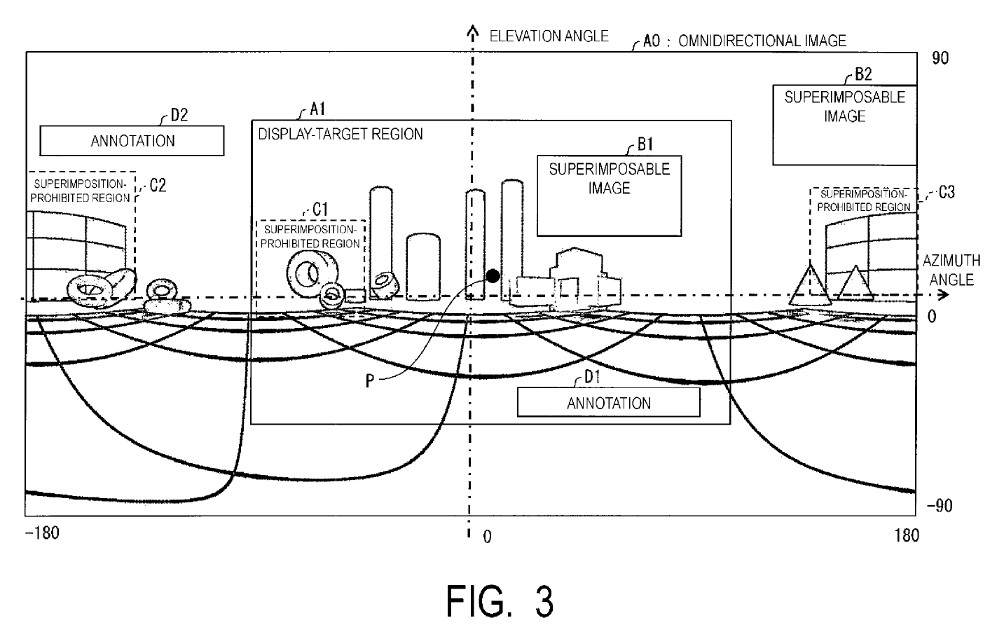

An image to be displayed by the display device 1 will be described below based on FIG. 3. FIG. 3 is a diagram illustrating an image to be displayed by the display device 1. In FIG. 3, the omnidirectional image A0 is expressed in a planar shape. As described above, the display-target region A1 is a portion of the display region of the omnidirectional image A0, and the center position of the display-target region A1 is indicated by the symbol P (see FIG. 2). Any position on the omnidirectional image A0 can be represented by a combination of an azimuth angle θ (−180°≤θ≤180°) and an elevation angle φ (−90°≤φ≤90°), which is the rotation angle about the horizontal axis (i.e., the x-axis). In the illustrated example, the azimuth angle of the left end of the omnidirectional image A0 is −180°, the azimuth angle of the right end thereof is 180°, the elevation angle of the upper end is 90°, and the elevation angle of the lower end is −90°.

Superimposable images B1 and B2 as well as annotations D1 and D2 are superimposed over the omnidirectional image A1. These are superimposable objects that are to be superimposed over the omnidirectional image A0. Note that in a case where it is not necessary to distinguish the superimposable images B1 and B2 from each other, any of the superimposable images B1 and B2 is referred to as the superimposable image B. The same rule applies to the annotations D1 and D2. In addition, superimposition-prohibited regions C1 to C3 are defined in the omnidirectional image A0. The superimposition-prohibited regions C1 to C3 will be described later in Embodiment 2.

The superimposable image B is an image obtained by capturing the same imaging target as the imaging target of the omnidirectional image A0 (a streetscape in the present example), but the superimposable image B is captured by use of a different imaging device from the one used for capturing the omnidirectional image A0. In addition, the superimposable image B is a higher-resolution image than the omnidirectional image A0, and is thus a higher-definition image than the omnidirectional image A0. The superimposable image B may be, for example, an image obtained by capturing the same imaging target as that of the omnidirectional image A0 from the same angle as that of the omnidirectional image A0. Alternatively, the superimposable image B may be an image obtained by capturing the same imaging target as that of the omnidirectional image A0 from a different angle from that of the omnidirectional image A1. Still alternatively, the superimposable image B may be an enlarged image of a portion of the imaging target of the omnidirectional image A0. The superimposable image B may be a video, or may be a still image.

Displaying the superimposable image B gives the user multifaceted information on the imaging target of the omnidirectional image A0. For example, in a case where an enlarged high-resolution image of a specific building in the display-target region A1 is used as the superimposable image B, the user can take a glance through the overall image of the streetscape and concurrently, can look into the details of a portion of a particular building. Now suppose an alternative case where, for example, an image of a particular building in the display-target region A1 is captured from a different angle from that of the omnidirectional image A0 and where the image thus captured is used as the superimposable image B. Though the omnidirectional image A0 captured from a particular angle leaves some portions of the particular building unimaged, the user can also observe such an unimaged portions in the superimposable image B.

The annotation D is information displayed as a note on either the omnidirectional image A0 or the superimposable image B, and is a type of superimposable image. The content of the annotation D is not particularly limited as long as it relates to either the omnidirectional image A0 or the superimposable image B. For example, the information on the omnidirectional image A0 may be information indicating the state of the imaging target, the action thereof, the name thereof, a noteworthy portion of the omnidirectional image A0, and the like. Note that in a case where a noteworthy portion of the omnidirectional image A0 is not included in the display-target region A1, the annotation D preferably intended to guide the user to allow the noteworthy portion to come and stay in the display-target region A1. For example, a possible message that may be displayed as annotation D is “Turn your eyes rightwards towards the triangular building”. Another possible message that may be displayed as annotation D is a message to guide the user's gaze direction to a prescribed gaze direction, such as “Turn your eyes a bit leftwards to position of the cylindrical low building at the center of your field of vision”. Further, some examples of the information related to the superimposable image B are: information on which angle the superimposable image is captured from; and information on which portion of the imaging target the superimposable image B corresponds to. In addition, for example, a User Interface (UI) menu or the like for operating the display device 1 may be displayed as the annotation D.

In the example of FIG. 3, a streetscape image is captured as the imaging target of the omnidirectional image A0, but anything may be captured as the imaging target of the omnidirectional image A0. For example, the omnidirectional image A0 may be an image of an overall scene in an operating room Where a surgical operation is going on. In this case, the imaging target may include a surgeon, an assistant, a patient, surgical instruments, various kinds of apparatuses, and the like. Use of such an image as the omnidirectional image A0 allows the display device 1 to be used for medical-education purposes.

For example, in a case where the superimposable image B is an image captured along the gaze of a person in the superimposable image A0, such as the surgeon or the assistant, the user can learn what each person should keep watch on during a surgical operation while the user can observe the overall progress of the surgical operation by use of the omnidirectional image A0. Note that, the subject whose gaze is to be displayed as an image may be made switchable depending on what the purpose of learning is. For example, in a case where the display device 1 is used in the education of surgeons, the superimposable image B of the surgeon's gaze may be displayed. In an alternative case where the display device 1 is used in the education of the assistants, the superimposable image B of the assistant gaze may be displayed. Also, in a case where an image of the screen displaying vital data of the patient is used as the superimposable image B, the user can recognize the relationship between the changing vital data during the operation and the actions to be taken by each person corresponding to such changes. Further alternatively, a high resolution image of the surgical field, for example, may be used as the superimposable image B. Such use allows the user to recognize the details of the work done by the surgeon. In addition, information required in the surgery, information on the manipulation of devices (for example, the on/off of the heart-lung machine) and/or the like may be displayed as the annotation D. In addition, in a case where there is a noteworthy portion outside of the display-target region A1, a message such as “Move your eyes rightwards to check the measurements on the instruments” may be displayed as the annotation D to prompt the user to move his/her eyes.

### Examples of Superimposable-Image Management Information

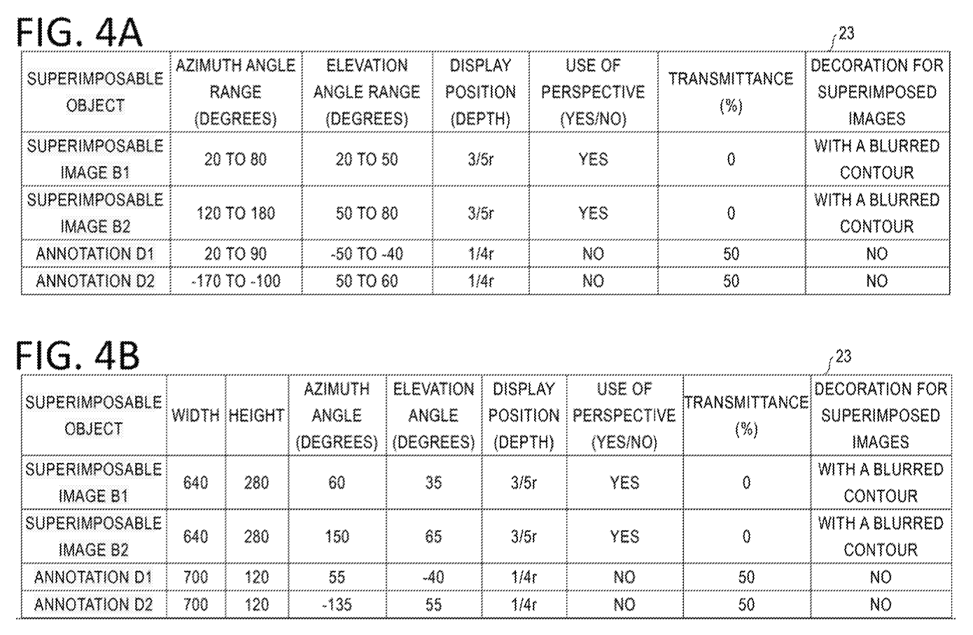

The superimposable-image management information 23 may be information such as the ones shown in FIGS. 4A and 4B. FIGS. 4A and 4B are diagrams illustrating exemplar pieces of superimposable-image management information 23. The superimposable-image management information 23 in FIG. 4A shows table-type data in which the following kinds of information are listed as being associated with one another: the superimposable object; the azimuth angle range; the elevation angle range; the display position (depth); the use of perspective (yes/no); the transmittance; and the decoration for superimposed images.

The “superimposable object” is information indicating a superimposable object, and in the present example, the name of each superimposable object is in the cell. The “azimuth angle range” and the “elevation angle range” are information indicating the display region of each superimposable object. For example, the superimposable image B1 has an azimuth angle range from 20° to 80° and an elevation angle range from 20° to 50°. Thus, the superimposable image B1 is displayed in a rectangular region having an azimuth angle of 20° at the left end, an azimuth angle of 80° at the right end, an elevation angle of 20° at the bottom end, and an elevation angle of 50° at the upper end. The “display position (depth)” is information indicating the display position in the depth direction of the superimposable object. Here, the display position in the depth direction of each superimposable object is indicated by use of the symbol r representing the display position on the deepest side (see FIG. 2).

The “use of perspective (yes/no)”, the “transmittance”, and the “decoration for superimposed images” are information indicating the display modes of the superimposable object. Specifically, the “use of perspective (yes/no)” is information indicating whether to use a perspective display, i.e., the perspective projection for displaying an image. A superimposable object with use of perspective is displayed in a three-dimensional manner by use of the perspective projection, but a superimposable object without use of perspective is displayed without using the perspective projection. The “transmittance” is information indicating the transmittance of each superimposable object. If the transmittance of a superimposable object is greater than zero, the underlying omnidirectional image in the portion over which the superimposable object is superimposed is visually recognizable. The “decoration for superimposed image” is information indicating whether to perform an image processing that blurs the contour of the superimposable object.

On the other hand, in the superimposable-image management information 23 in FIG. 4B, the “azimuth angle range” and the “elevation angle range” included in the superimposable-image management information 23 in FIG. 4A are replaced by the “width”, the “height”, the “azimuth angle”, and the “elevation angle”. To put it differently, in the superimposable-image management information 23 of FIG. 4B, the “width”, the “height”, the “azimuth angle”, and the “elevation angle” are the information indicating the display region of each superimposable object. Specifically, the “width” and the “height” indicate the width and the height of the superimposable object, respectively. In addition, the “azimuth angle” and the “elevation angle” together indicate the reference position used for identifying the display region of each superimposable object. The reference position can be any position on the superimposable object. For example, in a case where the superimposable object is rectangular, the position of the lower left corner thereof may be used as the reference position. In this case, the lower left corner is a position indicated by the “azimuth angle” and the “elevation angle”, and the region having a width and a height indicated by the “width” and the “height”, respectively, becomes the display region of the superimposable object.

### Flow of Processing

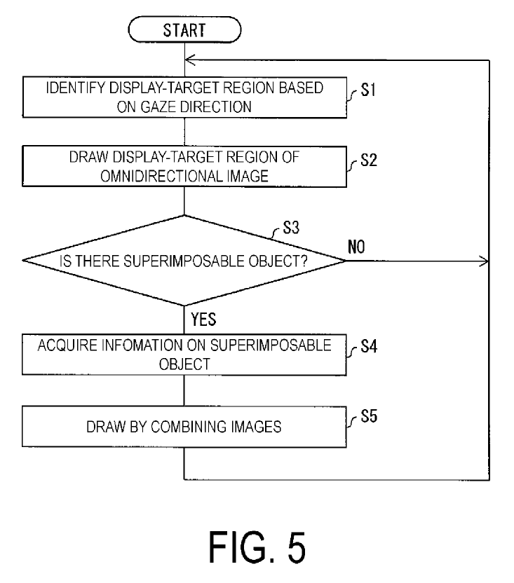

An exemplar flow of processing to be performed by the display device 1 (a method for controlling the display device) will be described based on FIG. 5. FIG. 5 is a flowchart describing an exemplar processing to be performed to cause the display device 1 to display an image.

At Step S1 (region identifying step), the gaze-direction identifying unit 17 identifies the gaze direction of the user wearing the display device 1, and the omnidirectional image rendering unit 12 identifies the display-target region in the omnidirectional image 22 based on the gaze direction identified by the gaze-direction identifying unit 17. Then, at Step S2, the omnidirectional image rendering unit 12 makes the combining unit 16 cause the display unit 19 to draw (display) a partial image of the omnidirectional image 22 corresponding to the identified display-target region.

At Step S3, the superimposable-image selecting unit 14 determines whether there is a superimposable object that is to be displayed in the display-target region identified by the omnidirectional image rendering unit 12. Specifically, the superimposable-image selecting unit 14 determines whether at least a portion of a prescribed region indicated by the superimposable-image management information 23 (i.e., a region identified by the azimuth angle range and the elevation angle range) is included in the display-target region. If such a region is included in the display-target region, the superimposable-image selecting unit 14 determines that there is a superimposable object, and if not, the superimposable-image selecting unit 14 determines that there is no superimposable object. Here, in the case where the superimposable-image selecting unit 14 determines that there is a superimposable object (YES at Step S3), the superimposable-image selecting unit 14 identifies the superimposable object as the object to be superimposed over the omnidirectional image. Then, the processing proceeds to Step S4. In contrast, in a case where the superimposable-image selecting unit 14 determines that there is no superimposable object (NO at Step S3), the processing returns to Step S1.

At Step S4 (position determining step), the superimposing-position determining unit 15 acquires, from the superimposable-image management information 23, information indicating the superimposing position, the display modes, and the like of the superimposable object identified by the superimposable-image selecting unit 14, For example, in a case of using the superimposable-image management information 23 shown in FIG. 2A, the superimposing-position determining unit 15 acquires pieces of information indicating the azimuth angle range, the elevation angle range, the display position (depth), the use of perspective (yes/no), the transmittance, and the decoration for superimposed images. Then, based on the acquired information, the superimposing-position determining unit 15 determines the superimposing position of the superimposable object in accordance with the contents of the partial image. Here, since the prescribed region identified by the azimuth angle range and the elevation angle range is in the display-target region, the superimposing-position determining unit 15 determines that the display position of the superimposable object is within the prescribed region. In addition, based on the information on the display position (depth), the superimposing-position determining unit 15 determines the display position in the depth direction of the superimposable object. In addition, the superimposing-position determining unit 15 determines display modes of the superimposable object based on the pieces of information indicating the use of perspective (yes/no), the transmittance, and the decoration for superimposed images.

At Step S5 (superimposing step), the combining unit 16 combines the superimposable object with the display-target region portion of the omnidirectional image drawn at Step S2, and causes the display unit 19 to display the resultant image. At this time, the combining unit 16 loads the superimposable image 24 from the storage unit 21, and combines the loaded superimposable image 24 with the display-target region portion of the omnidirectional-image at the at the position determined by the superimposing-position determining unit 15 at Step S4 and in the mode determined by the superimposing-position determining unit 15 at Step S4. Then, the processing returns to Step S1.

Note that the displaying with superimposition may be terminated in a case where the movement of the user's gaze direction, the progress of playback of the contents, or the like, leave no more superimposable objects that should be displayed as being superimposed. In contrast, a superimposable object may be set as an object that is made to be displayed continuously as being superimposed irrespective of the movement of the user's gaze direction, the progress of playback of the contents, or the like. Such a superimposable object may be associated with attribute information indicating that the superimposable object is continuously displayed as being superimposed. Such attribute information may be included in, for example, the superimposable-image management information 23, The conditions for continuously displaying as being superimposed may also be associated with such a superimposable object. As a result, a superimposable-object video, for example, can be continuously displayed at a position such that the video cannot be lost from the user's sight until the playback of the video is completed.

### Embodiment 2

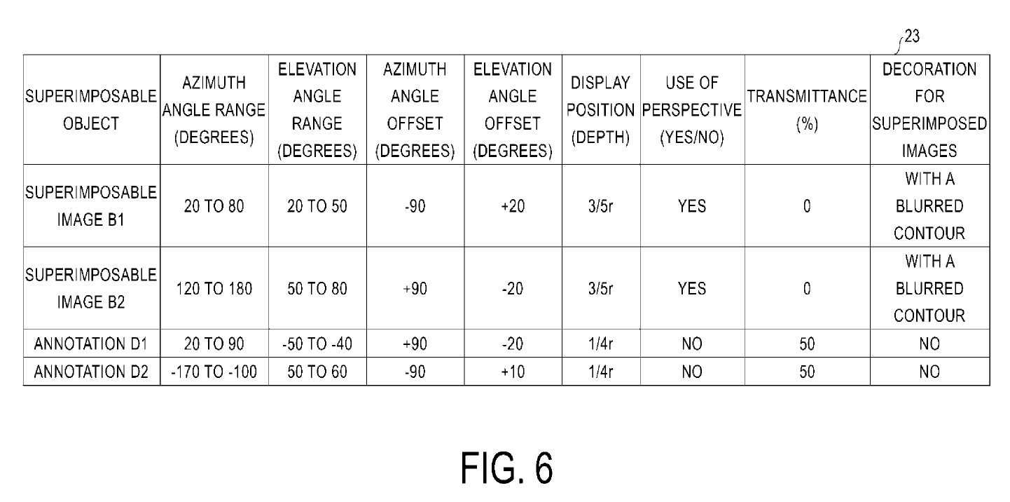

Another embodiment of the disclosure will be described below based on FIG. 6 to FIG. 8. For convenience of explanation, members having the same functions as those of the members described in the foregoing embodiment are denoted by the same reference signs, and the descriptions thereof will be omitted. The same rule applies to the third embodiment onwards.

The display device 1 according to the present embodiment displays a superimposable object at a prescribed position in the display-target region. However, in a case where the prescribed position is in the superimposition-prohibited region, the display position of the superimposable object is corrected so that the superimposable object is displayed at a position outside of the superimposition-prohibited region.

### Examples of Superimposable-Image Management Information

As described above, since the display device 1 according to the present embodiment displays the superimposable object at a prescribed position in the display-target region, the superimposable-image management information 23 of the present embodiment indicates a positional relationship between the reference position in the display-target region and the superimposable object. The superimposable-image management information 23 of the present embodiment may be one that is illustrated in FIG. 6, for example.

FIG. 6 is a chart indicating an example of the superimposable-image management information 23 indicating a positional relationship between the reference position in a display-target region and the superimposable object. The superimposable-image management information 23 in FIG. 6 includes the pieces of the superimposable-image management information 23 of FIG. 4A, and also includes the “azimuth angle offset” and the “elevation angle offset”. In addition, while the “azimuth angle range” and the “elevation angle range” in the superimposable-image management information 23 in FIG. 4A indicates the display region of the superimposable object, but the “azimuth angle range” and the “elevation angle range” in the superimposable-image management information 23 in FIG. 6 indicate display conditions for the superimposable object. To put it differently, in the present embodiment, the superimposable-image selecting unit 14 selects a superimposable object as the superimposable object to be displayed as being superimposed on the condition that the reference position of the display-target region is within the “azimuth angle range” shown in the superimposable-image management information 23 of FIG. 6 and within the “elevation angle range” shown in the same information 23.

The “azimuth angle offset” and the “elevation angle offset” together indicate the offset of the display position of the superimposable object in relation to the reference position in the display-target region. The reference position in the display-target region may be determined in advance, and may be, for example, the center of the display-target region. In this case, for example, the superimposable image 131 indicated in FIG. 6 is displayed as being centered on the position (which may be the upper left corner or the like) that is −90° shifted in the azimuthal direction and +20° shifted in the elevation angle direction from the center of the display-target region. In this way, by determining the display position of the superimposable object so that the superimposable object and the reference position are in a prescribed positional relationship, the superimposable object can be more viewable.

### Extraction of Superimposition-Prohibited Region

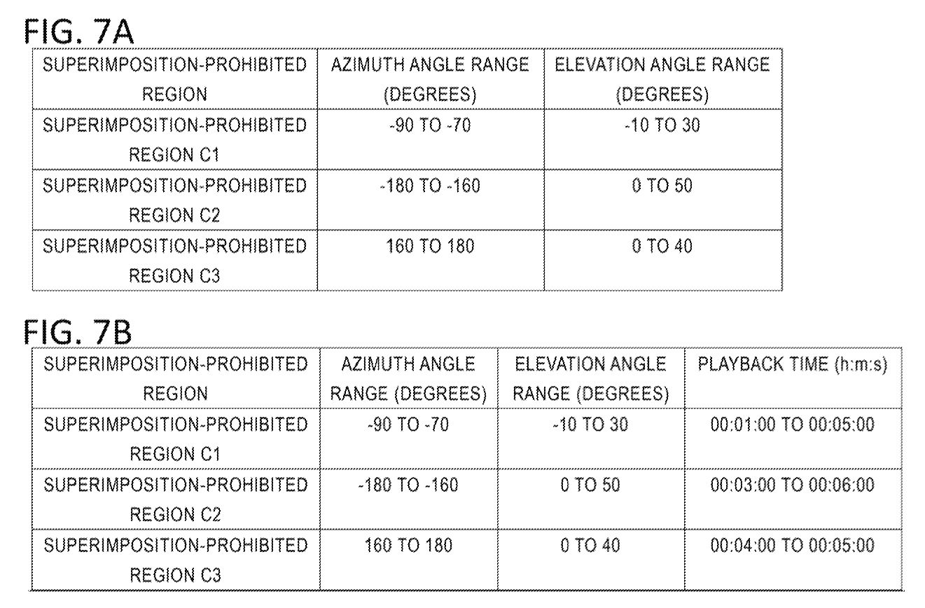

The display device 1 according to the present embodiment is configured to prevent the superimposable object from being displayed in the superimposition-prohibited region by extracting the superimposition-prohibited region from the display-target region. The extraction of the superimposition-prohibited region will be described below based on FIGS. 7A and 7B. FIGS. 7A and 7B are diagrams illustrating exemplar pieces of information indicating superimposition-prohibited regions. The superimposition-prohibited region may be set while the display device 1 is displaying an image (while playing contents) or may be set in advance. Firstly, an example where a superimposition-prohibited region is set while an image is being displayed (while playing contents) will be described based on FIG. 7A. Then, an example where the superimposition-prohibited region is set in advance will be described based on FIG. 7B.

In a case where the superimposition-prohibited region is set during the playback of contents, the target detecting unit 13 detects, from the partial image of the omnidirectional image, a superimposition-prohibited object, that is, an object over which no superimposable object is allowed to be superimposed. Note that the entire image region of the omnidirectional image may be used as the detection target. In addition, the kind(s) of object that should be the superimposition-prohibited object(s) may be defined in advance. For example, by defining prescribed appearances (shape, size, color, and the like) in advance as the appearances of superimposition-prohibited objects, the target detecting unit 13 can automatically detect any object with such an appearance as a superimposition-prohibited object. Alternatively, a machine learning technology or the like may be used for the detection of superimposition-prohibited objects.

Then, the superimposing-position determining unit 15 identifies a superimposition-prohibited region that includes the detected superimposition-prohibited object. The identified superimposition-prohibited region can be expressed as pieces of information, such as the ones shown in FIG. 7A. In the example illustrated in FIG. 7A, one “azimuth angle range” and one “elevation angle range” are associated with each “superimposition-prohibited region”. The “azimuth angle range” and the “elevation angle range” are set to values that make the corresponding values of the superimposition-prohibited object be included in that “azimuth angle range” and that “elevation angle range”. For example, the azimuth angle of the left end and the azimuth angle of the right end of the superimposition-prohibited object may be used as the lower limit and the upper limit of the “azimuth angle range”, respectively. Likewise, the elevation angle of the upper end and the elevation angle of the lower end of the superimposition-prohibited object may be used as the lower limit and the upper limit of the “elevation angle range”, respectively.

Note that in a case where the movement of the user's gaze direction causes the superimposition-prohibited object to be located outside of the display-target region, or in a case where the progress of the playback of the contents makes the superimposition-prohibited object be excluded from the omnidirectional image, the superimposing-position determining unit 15 cancels the settings of the superimposition-prohibited region.

In a case where the superimposition-prohibited region is set in advance, the prohibited-region information indicating the superimposition-prohibited region thus set may be stored in the storage unit 21 or the like. The prohibited-region information in this case may be, for example, the one shown in FIG. 7B. The prohibited-region information includes the pieces of information shown in FIG. 7A, and additionally includes the “playback time” corresponding to each of the superimposition-prohibited regions shown in FIG. 7A. The “playback time” is information indicating a playback time period in which the superimposition-prohibited region is set. The superimposing-position determining unit 15 identifies the superimposition-prohibited region based on the prohibited-region information. For example, in a case where the playback time of the contents is included in the time period from minute 1 to minute 5, the superimposing-position determining unit 15 identifies the superimposition-prohibited region C1 as the superimposition-prohibited region, and extracts, as the superimposition-prohibited region, a region whose azimuth angle ranges from −90° to −70°, and whose elevation angle ranges from −10° to 30°.

### Flow of Processing

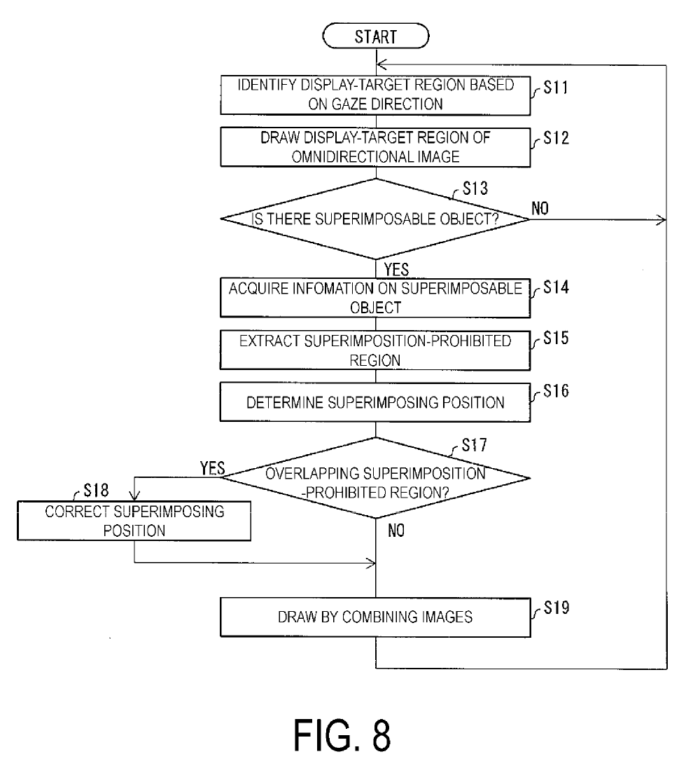

An exemplar flow of processing to be performed by the display device 1 (a method for controlling the display device) will be described based on FIG. 8. FIG. 8 is a flowchart describing an exemplar processing to be performed to cause the display device 1 to display an image. Note that Step S11 (region identifying step), and Steps S12 and S19 (superimposing steps) in FIG. 8 are processes that are similar respective to the ones of Steps S1, S2, and S5 in FIG. 5. Hence, descriptions thereof will be omitted.

At Step S13, the superimposable-image selecting unit 14 determines whether there is a superimposable object to be displayed in the display-target region identified by the omnidirectional image rendering unit 12. Specifically, the superimposable-image selecting unit 14 identifies the azimuth angle and the elevation angle of the reference position of the display-target region. Then, the superimposable-image selecting unit 14 refers to the superimposable-image management information 23, and determines whether there is a superimposable object whose azimuth angle and whose elevation angle satisfy the display conditions. Here, in the case where the superimposable-image selecting unit 14 determines that there is a superimposable object (YES at Step S13), the superimposable-image selecting unit 14 identifies the superimposable object as the object to be superimposed over the omnidirectional image. Then, the processing proceeds to Step S14. In contrast, in a case where the superimposable-image selecting unit 14 determines that there is no superimposable object (NO at Step S13), the processing returns to Step S11.

At Step S14, the superimposing-position determining unit 15 acquires, from the superimposable-image management information 23, information indicating the superimposing position, the display modes, and the like of the superimposable object identified by the superimposable-image selecting unit 14. For example, in a case of using the superimposable-image management information 23 shown in FIG. 6, the superimposing-position determining unit 15 acquires pieces of information indicating the azimuth angle offset, the elevation angle offset, the display position (depth), the use of perspective (yes/no), the transmittance, and the decoration for superimposed images.

At Step S15, the superimposing-position determining unit 15 extracts the superimposition-prohibited region. The method of extracting the superimposition-prohibited region is described earlier with reference to FIGS. 7A and 7B. Note that the process at Step S15 may be performed prior to the process at Step S14 or processes at Steps S14 and S15 may be performed in parallel.

At Step S16, based on the information on the azimuth angle offset, the elevation angle offset, and the display position (depth) acquired at Step S14, the superimposing-position determining unit 15 determines the superimposing position at which the superimposable object is to be superimposed. In addition, the superimposing-position determining unit 15 determines the display modes of the superimposable object based on the information indicating the use of perspective (yes/no the transmittance, and the decoration for superimposed images acquired at Step S14.

At Step S17, the superimposing-position determining unit 15 determines whether the superimposing position determined at Step S16 overlaps the superimposition-prohibited region extracted at Step S15. In a case where the superimposing-position determining unit 15 determines that the superimposing position overlaps the superimposition-prohibited region (YES at Step S17), the processing proceeds to Step S18, and otherwise (NO at Step S17), the processing proceeds to Step S19.

At Step S18 (position determining step), the superimposing-position determining unit 15 corrects the superimposing position determined as above so that the corrected superimposing position does not overlap the superimposition-prohibited region extracted at Step S15. In this way, by correcting (determining) the superimposing position of the superimposable object in accordance with the contents of the partial image, the superimposable object can be displayed at a position suitable for the contents of the partial image. The correction may be a correction in the elevation angle direction, may be a correction in the azimuth angle direction, or may be a combination thereof. For example, in a case where the elevation angle offset has a positive value; the elevation angle of the superimposition position may be increased until the superimposing position stops overlapping the region extracted at Step S15. Conversely, in a case where the elevation angle offset has a negative value, the elevation angle of the superimposition position may be decreased until the superimposing position stops overlapping the region extracted at Step S15. Consequently, the display position of the superimposable object becomes outside of the superimposition-prohibited region, After Step S18, the processing proceeds to Step S19.

### Embodiment 3

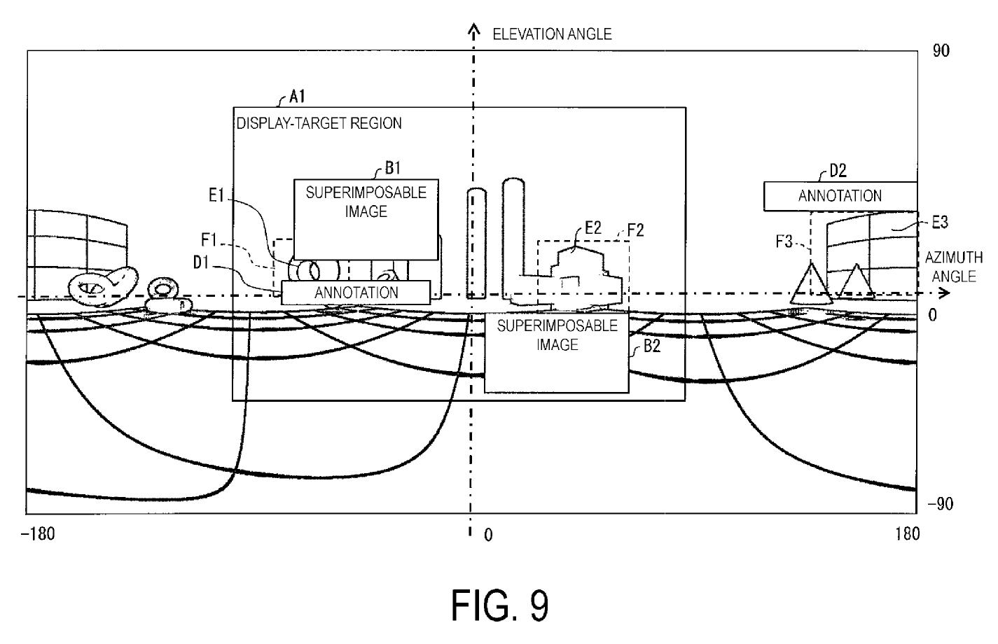

Yet another embodiment of the disclosure will be described below based on FIG. 9 to FIG. 12. The description in the present embodiment is based on an example where the superimposable object is displayed in association with a prescribed detection target included in the omnidirectional image.

### Image to be Displayed

An image to be displayed by the display device 1 of the present embodiment will be described below based on FIG. 9. FIG. 9 is a diagram for explaining an example where the superimposable object is displayed in association with a prescribed detection target included in the omnidirectional image.

In the example of FIG. 9, three detection targets E1 to E3 are defined in the omnidirectional image. Also, rectangular regions F1 to F3 including their respective detection targets are also defined. In a case where one or more of the detection targets E1 to E3 are included in the display-target region, the display device 1 of the present embodiment causes the superimposable object in association with the included one or more of the detection targets E1 to E3. For example, in the example illustrated in FIG. 9, since the detection targets E1 and E2 are included in the display-target region A1, the display device 1 displays the superimposable image B1 and the annotation D1 in association with the detection target E1, and displays the superimposable image B2 in association with the detection target E2. In a case where the display-target region A1 moves and the detection target E3 has come to be located in the display-target region A1, the display device 1 displays the annotation D2 in association with the detection target E3.

In this way, because the display device 1 of the present embodiment causes the superimposable object to be displayed in association with the detection target, the user can easily recognize the association between the detection target and the superimposable object. For example, because an image of a detection target captured from a different angle from the angle for the omnidirectional image is displayed as a superimposable image in association with the detection target, the user can recognize easily that the superimposable image is an image of the same detection target captured from the different angle.

### Examples of Superimposable-Image Management Information

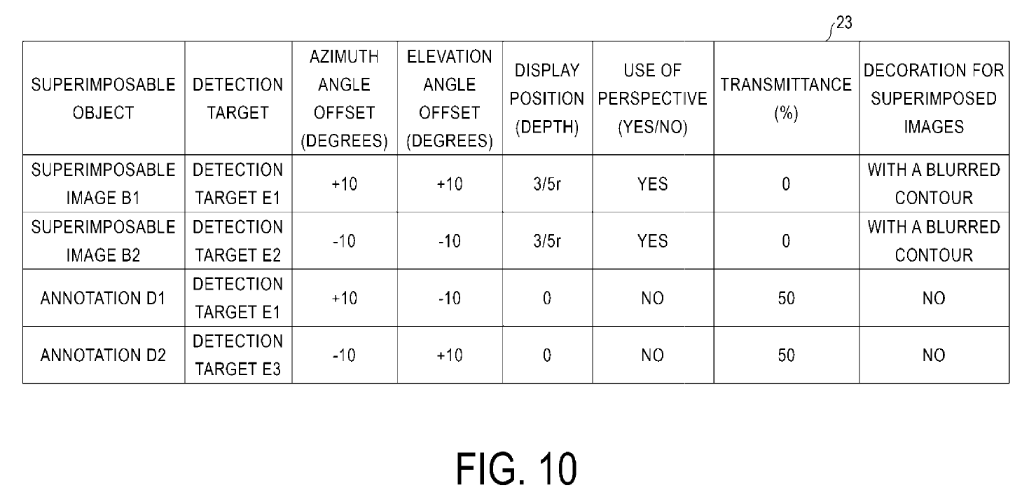

The superimposable-image management information 23 used in the present embodiment may be one that is illustrated in FIG. 10, for example. FIG. 10 is a chart indicating exemplar superimposable-image management information 23 that is to be used in a case where a superimposable object is displayed in association with a detection target.

In the superimposable-image management information 23 in FIG. 10, the “azimuth angle range” and the “elevation angle range” included in the superimposable-image management information 23 in FIG. 4A are replaced by the “detection target”, the “azimuth angle offset”, and the “elevation angle offset”.

The detection target indicates a prescribed detection target included in the omnidirectional image. In the present example, the detection targets E1 to E3 of FIG. 9 are listed as examples. In addition, the “azimuth angle offset” and the “elevation angle offset” together indicate the relative display position of each superimposable object in relation to the position of the detection target. To put it differently, a position shifted from the position of the detection target by the value of the azimuth angle offset and the value of the elevation angle offset is used as the display position of the superimposable object. For example, in the present example, the superimposable image B2 is associated with the detection target E2 with the azimuth angle offset of −10° and the elevation angle offset of −10°. Thus, the display position of the superimposable image B2 is determined by use of a reference position obtained by shifting the reference position of the detection target E2 by −10° in the azimuth angle direction and by −10° in the elevation angle direction. Note that the above-mentioned reference position has only to be a position located within the detection target E2 or the region F2 including the detection target E2 (see FIG. 9), and may be, for example, a center position of the region F2. In this case, the superimposable image 132 may be displayed so that the center position is the position obtained by shifting from the center position of the region F2 by −10° in the azimuth angle direction and by −10° in the elevation angle direction (e.g., the center position may be the upper left corner, or the like).

### Extraction of Region Including Detection Target

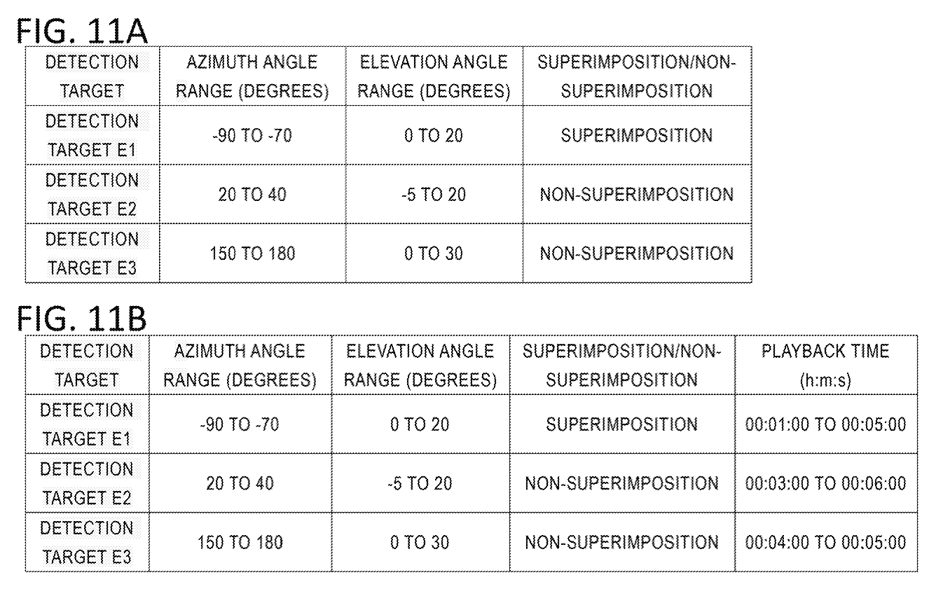

The extraction of the region including the detection target (see regions F1 to F3 in FIG. 9) will be described below based on FIGS. 11A and 11B. FIGS. 11A and 11B are diagrams illustrating an example of information indicating a region including a detection target. The region including the detection target may be set while the display device 1 is displaying an image (while playing contents) or may be set in advance. Firstly, an example where a region occupied by the detection target is set during the playback of the contents will be described based on FIG. 11A. Then, an example where the region occupied by the detection target is set in advance will be described based on FIG. 11B.

In a case where the region including the detection target is set during the playback of contents, the target detecting unit 13 detects the detection target from the partial image of the omnidirectional image. Note that the entire image region of the omnidirectional image may be used as the detection target. In addition, the kind(s) of object that should be the detection target(s) may be defined in advance. For example, by defining prescribed appearances (shape, size, color, and the like) in advance as the appearances of detection targets, the target detecting unit 13 can automatically detect any object with such an appearance as a detection target. Alternatively, a machine learning technology or the like may be used for the detection of objects that should be the detection targets.

Then, the superimposing-position determining unit 15 identifies a region that includes the detected detection target. The identified region can be expressed as pieces of information, such as the ones shown in FIG. 11A. In the example of FIG. 11A, the “azimuth angle range” and the “elevation angle range” as well as the “superimposition/non-superimposition” are associated with each “detection target”. The “azimuth angle range” and the “elevation angle range” are set to values that make the corresponding values of the detection target be included in that “azimuth angle range” and that “elevation angle range”. For example, the azimuth angle of the left end and the azimuth angle of the right end of the detection target may be used as the lower limit and the upper limit of the “azimuth angle range”, respectively. Likewise, the elevation angle of the upper end and the elevation angle of the lower end of the detection target may be used as the lower limit and the upper limit of the “elevation angle range”, respectively. The “superimposition/non-superimposition” is information indicating whether the superimposable object is allowed to be superimposed over the detection target.

Note that in a case where the movement of the user's gaze direction causes the detection target to be located outside of the display-target region, or in a case where the progress of the playback of the contents makes the detection target be excluded from the omnidirectional image, the superimposing-position determining unit 15 cancels the settings of the region.

In a case where the region including the detection target is set in advance, the detection-target information indicating the region thus set may be stored in the storage unit 21 or the like. The detection-target information may be, for example, the one shown in FIG. 11B. The detection-target information includes the pieces of information shown in FIG. 11A, and additionally includes the “playback time” corresponding to each of the detection targets shown in FIG. 11A. The “playback time” is information indicating a playback time period in which the region including the detection target is set. The superimposing-position determining unit 15 identifies the region that includes the detected detection target based on the detection-correspondence information. For example, in a case where the playback time of the contents is included in the time period from minute 1 to minute 5, the superimposing-position determining unit 15 identifies the detection target E1 as the detection target, and extracts, as a region including the detection target, a region whose azimuth angle ranges from −90° to −70° and whose elevation angle ranges from −10° to 20°.

### Flow of Processing

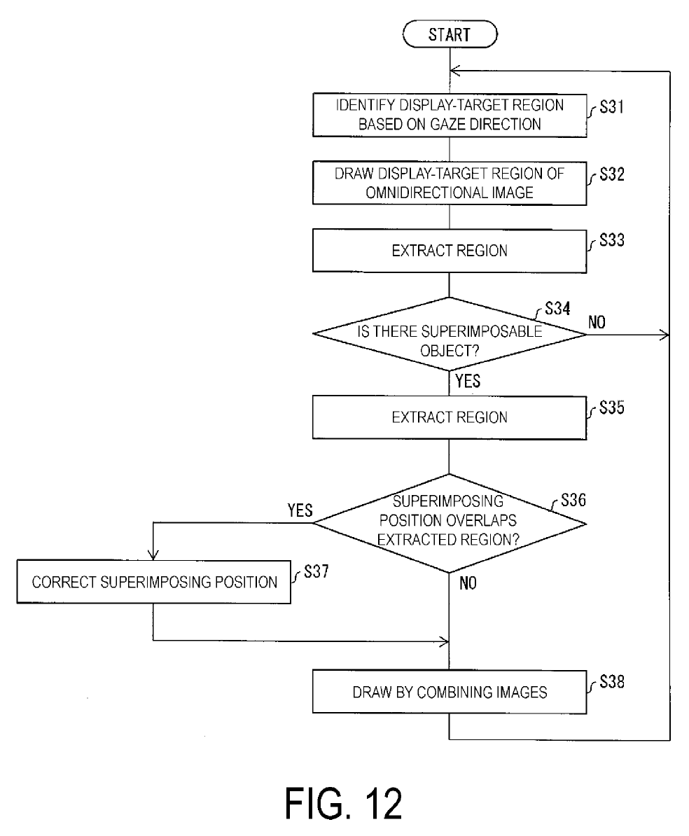

An exemplar flow of processing to be performed by the display device 1 (a method for controlling the display device) will be described based on FIG. 12. FIG. 12 is a flowchart describing an exemplar processing to be performed to cause the display device 1 to display an image. Note that Step S31 (region identifying step), and Steps S32 and S38 (superimposing steps) in FIG. 12 are processes that are similar respectively to the ones of Steps S1, S2, and S5 in FIG. 5, Hence, descriptions thereof will be omitted.

At Step S33, the target detecting unit 13 extracts a region including the detection target from the display-target regions of the omnidirectional image. The method of extracting the region is described earlier with reference to FIGS. 11A and 11B. Note that in a case where no detection target is included in any of the detection-target regions, the processing proceeds to Step S34 without extracting any region.

At Step S34, the superimposable-image selecting unit 14 determines whether there is a superimposable object that is to be displayed in association with the region extracted by the target detecting unit 13. Specifically, the superimposable-image selecting unit 14 determines whether there is a superimposable object associated with the extracted region (or the detection target included in the region) in the superimposable-image management information 23. Here, in the case where the superimposable-image selecting unit 14 determines that there is a superimposable object (YES at Step S34), the superimposable-image selecting unit 14 identifies the superimposable object as the object to be superimposed over the omnidirectional image. Then, the processing proceeds to Step S35. In contrast, in a case where the superimposable-image selecting unit 14 determines that there is no superimposable object (NO at Step S34), the processing returns to Step S31.

At Step S35, the superimposing-position determining unit 15 acquires, from the superimposable-image management information 23, information indicating the superimposing position, the display modes, and the like of the superimposable object identified by the superimposable-image selecting unit 14. For example, in a case of using the superimposable-image management information 23 shown in FIG. 10, the superimposing-position determining unit 15 acquires pieces of information indicating the azimuth angle offset, the elevation angle offset, the display position (depth), the use of perspective (yes/no), the transmittance, and the decoration for superimposed images.

At Step S36, based on the information on the azimuth angle offset, the elevation angle offset, and the display position (depth) acquired in the above-described manner, the superimposing-position determining unit 15 determines the superimposing position at which the superimposable object is to be superimposed. In addition, the superimposing-position determining unit 15 determines the display modes of the superimposable object based on the information indicating the use of perspective (yes/no), the transmittance, and the decoration for superimposed images acquired at Step S35. Then, the superimposing-position determining unit 15 determines whether the determined superimposing position overlaps the region extracted at Step S33. In a case where the superimposing-position determining unit 15 determines that the superimposing position overlaps the region (YES at Step S36), the processing proceeds to Step S17, and otherwise (NO at Step S36), the processing proceeds to Step S38. Note that in a case where the superimposable object has an attribute of the “superimposition” (see FIGS. 11A and 11B), the determination at Step S36 is omitted and the processing proceeds to Step S38.

At Step S37 (position determining step), the superimposing-position determining unit 15 corrects the superimposing position determined as above so that the corrected superimposing position does not overlap the region extracted at Step S33. In this way, by correcting (determining) the superimposing position of the superimposable object in accordance with the contents of the partial image, the superimposable object can be displayed at a position suitable for the contents of the partial image. This correction can be performed in the same manner as the correction performed at Step S18 in FIG. 8. The correction may cause the superimposable image B2 to be displayed so as not to overlap the detection target E2, as in the example of FIG. 9. After Step S37, the processing proceeds to Step S38.

### Embodiment 4

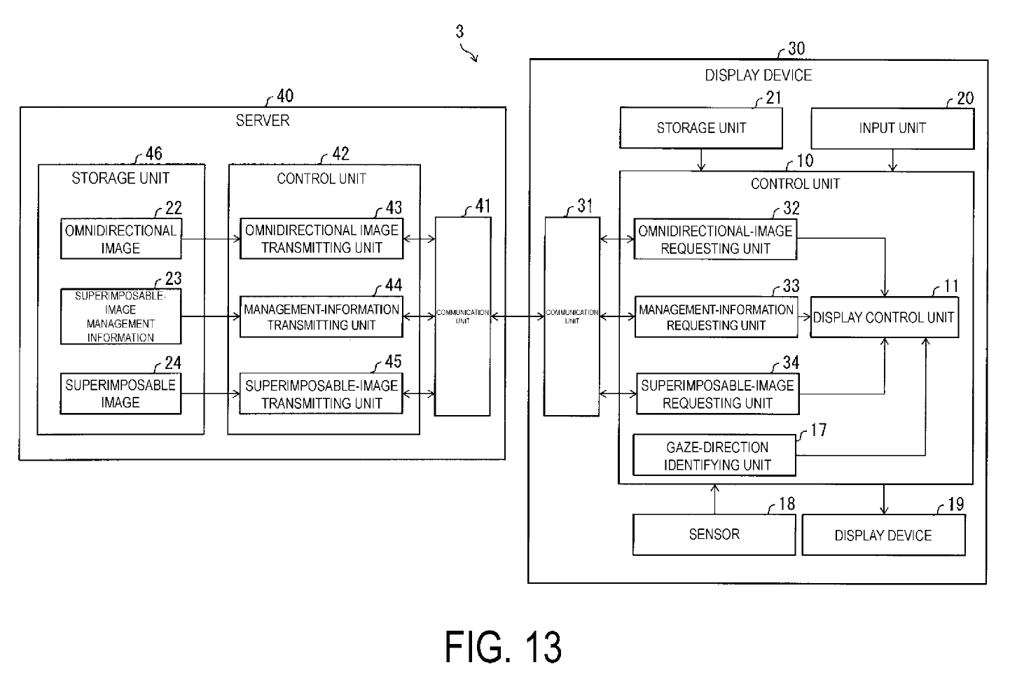

The functions of the display device 1 according to each of the above-described embodiments can also be implemented by a display control system including a server and a display device. FIG. 13 is a block diagram illustrating an exemplar main-portion configuration of a display device 30 and an exemplar main-portion configuration of a server 40, the display device 30 and the server 40 being included in a display control system 3 according to an embodiment of the disclosure.

The display device 30 differs from the display device 1 in that the storage unit 21 stores no omnidirectional image 22, no superimposable-image management information 23, or no superimposable image 24, and that the display device 30 includes a communication unit 31. In addition, the display device 30 differs from the display device 1 in that the control unit 10 includes an omnidirectional-image requesting unit 32, a management-information requesting unit 33, and a superimposable-image requesting unit 34.

The communication unit 31 is configured to allow the display device 30 to communicate with other devices. The omnidirectional-image requesting unit 32 is configured to acquire the omnidirectional image 22 from another device. The management-information requesting unit 33 is configured to acquire the superimposable-image management information 23 from another device. The superimposable-image requesting unit 34 is configured to acquire the superimposable image 24 from another device. Note that the description in the present embodiment is based on an example where all of the above-mentioned “another device(s)” are the server 40. Alternatively, at least one of the omnidirectional image 22, the superimposable-image management information 23, and the superimposable image 24 may be acquired from a device other than the server 40.

The server 40 is a device configured to transmit, to the display device 30, information that is necessary for the display device 30 to display an image. The server 40 includes: a communication unit 41 configured to allow the server 40 to communicate with another device (e.g., the display device 30 in the present embodiment); a control unit 42 configured to comprehensively control each unit of the server 40; and a storage unit 46 configured to store various kinds of data to be used by the server 40.

In addition, the control unit 42 includes: an omnidirectional-image transmitting unit 43 configured to transmit the omnidirectional image 22 in response to a request from another device; a management-information transmitting unit 44 configured to transmit the superimposable-image management information 23 in response to a request from another device; and a superimposable-image transmitting unit 45 configured to transmit the superimposable image 24 in response to a request from another device. Note that in the present embodiment, all of the above-mentioned “another device(s)” are the display device 30.

In the display control system 3, the omnidirectional-image requesting unit 32 of the display device 30 is configured to acquire the omnidirectional image 22 from the server 40 by means of the communication via the communication unit 31. The display control unit 11 makes the display unit 19 display the omnidirectional image 22 thus acquired. The management-information requesting unit 33 is configured to acquire the superimposable-image management information 23 from the server 40 by the communication via the communication unit 31. Based on the superimposable-image management information 23, the display control unit 11 selects the superimposable object that is to be displayed as being superimposed over the omnidirectional image 22. In addition, the display control unit 11 determines the display position and the display modes of the superimposable object to be displayed. Then, the superimposable-image requesting unit 34 acquires the superimposable image 24 from the server 40 by means of the communication via the communication unit 31. Then, the display control unit 11 makes the superimposable image 24 be displayed as being superimposed over the omnidirectional image 22.

Note that the display control unit 11 may be provided in the server 40. In this case, the server 40 serves as a display control device configured to control the displaying performed by the display device 30. Then, the display control unit 11 of the server 40 is configured to identify a display-target region based on the gaze direction identified by the gaze-direction identifying unit 17 of the display device 30, and then to make the superimposable image be displayed as being superimposed over the partial image in the display-target region. The display control unit 11 of the server 40 is configured also to determine the superimposing position of the superimposable image in accordance with the contents of the partial image.

### MODIFICATIONS

The description of each of the embodiments described above is based on an example where the user specifies the display-target region by directing his/her eyes in a desired direction, but the method for specifying the display-target region is not particularly limited. For example, the display-target region may be specified by a controller or the like configured to specify a display-target region.

Further, the description in each of the embodiments described above is based on an example where the superimposable object is displayed over a partial image of the omnidirectional image, but the target over which the superimposable object is to be superimposed is not limited to a partial image of the omnidirectional image. Instead, the target has only to be a partial image of the display-target region, which is a specified part of the entire image area. For example, the target may be a partial image of half celestial sphere image, or may be a planar image (e.g., a panoramic photograph) having a display size that does not fall within one screen of the display device 1 or 30, For example, in a case where an image is displayed to an ordinary scale, even an image of a display size that fits within one screen of the display device 1 or 30 may fail to fit within one screen when the image is displayed as being magnified. Hence, the superimposable object may be displayed in a state where the image is displayed as being magnified.

### Implementation Examples by Software

The control blocks (especially the unit included in the control units 10 and 42) of the display devices 1 and 30 and of the server 40 may be achieved with a logic circuit (hardware) formed as an integrated circuit (IC chip) or the like, or with software using a Central Processing Unit (CPU).

In the latter case, each of the display device 1, the display device 30, and the server 40 includes a CPU configured to perform commands of a program being software for achieving the functions, a Read Only Memory (ROM) or a storage device (these are referred to as “recording medium”) in which the program and various pieces of data are recorded in a computer-readable (or CPU-readable) manner, and a Random Access Memory (RAM) in which the program is loaded. The computer (or CPU) reads from the recording medium and performs the program to achieve the object of one aspect of the disclosure. As the above-described recording medium, a “non-transitory tangible medium” such as a tape, a disk, a card, a semiconductor memory, and a programmable logic circuit can be used. The above-described program may be supplied to the above-described computer via an arbitrary transmission medium (such as a communication network and a broadcast wave) capable of transmitting the program. Note that one aspect of the disclosure may also be implemented in a form of a data signal embedded in a carrier wave in which the program is embodied by electronic transmission.

### Supplement

A display control device (the display devices 1 and 30, and the server 40) according to a first aspect of the disclosure is a display control device that causes a display device (the display unit 19) to display a partial image of a specified display-target region within an image region of a captured image (the omnidirectional image 22) obtained by capturing an imaging target. The display control device includes: a region identifying unit (the omnidirectional image rendering unit 12) configured to identify the display-target region; and a superimposing unit (the combining unit 16) configured to cause a superimposable image (24) to be displayed as being superimposed over the partial image, the superimposable image being obtained by capturing at least a part of the imaging target by use of a different imaging device from an imaging device used for capturing the captured image.

According to the above-described configuration, a display-target region is identified, and a superimposable image, which is an image obtained by capturing, by use of a different imaging device from the imaging device used for capturing a captured image, the same imaging target as that of a captured image, is displayed as being superimposed over the partial image. This allows the imaging target to be shown to the user by means of the partial image and also by means of the superimposable image. In addition, since the superimposable image and the partial image are captured by use of different imaging devices from each other, these images include different pieces of information from each other. Thus, the user is allowed to recognize multifaceted information on the imaging target. To put it differently, the above-described configuration has an effect of improving the display content in a technique for displaying an image as being superimposed over the partial image of the specified display-target region in the image region.

A display control device according to a second aspect of the disclosure is the display control device of the first aspect that may further includes a position determining unit (the superimposing-position determining unit 15) configured to determine a superimposing position of the superimposable image in accordance with a content of the partial image.

The above-described configuration includes a position determining unit configured to determine the superimposing position of the superimposable image in accordance with the content of the partial image Hence, the superimposable image can be displayed at a position in accordance with the content of the partial image. Thus, the superimposable image can be displayed at a suitable position in accordance with the display content.

A display control device according to a third aspect of the disclosure is the display control device of the second aspect wherein in a case where a prescribed region of the captured image is included in the display-target region, the position determining unit may determine to cause a display position of the superimposable image to be within the prescribed region.

According to the above-described configuration, in a case where the prescribed region of the captured image is included in the display-target region, a superimposable image is displayed over the prescribed region. Thus, in a case where a user of the display device specifies a display-target region including a prescribed region, a superimposable image can be displayed over the prescribed region.

A display control device according to a fourth aspect of the disclosure is the display control device of the second or the third aspect that may further include a prohibited-region identifying unit (the superimposing-position determining unit 15) configured to identify, within the display-target region, an superimposition-prohibited region over which the superimposable image is not allowed to be superimposed. The position determining unit may define a display position of the superimposable image outside of the superimposition-prohibited region identified by the prohibited-region identifying unit.

According to the above-described configuration, a superimposition-prohibited region over which a superimposable image is not allowed to be superimposed is identified, and a superimposable image is displayed within the display-target region but outside of the superimposition-prohibited region. Hence, it is possible to prevent the image in the superimposition-prohibited region from becoming invisible due to the superimposable image. In addition, the user is allowed to view both the image in the superimposition-prohibited region and the superimposable image on a single screen.

A display control device according to a fifth aspect of the disclosure is the display control device of the fourth aspect that may further include: a prohibited-object detecting unit (target detecting unit 13) configured to detect a superimposition-prohibited object from the captured image, the superimposition-prohibited object being a part of the imaging target over which the superimposable image is not allowed to be superimposed. In the display control device, in a case where the prohibited-object detecting unit detects the superimposition-prohibited object in the display-target region, the prohibited-region identifying unit may identify the superimposition-prohibited region that includes the superimposition-prohibited object.

According to the above-described configuration, in a case where a superimposition-prohibited object is detected in the display-target region, an superimposition-prohibited region including the superimposition-prohibited object is identified. Hence, it is possible to prevent the image of the superimposition-prohibited object from becoming invisible due to the superimposable image. In addition, the user is allowed to view both the image of the superimposition-prohibited object and the superimposable image on a single screen.

A display control device according to a sixth aspect of the disclosure is the display control device of the first aspect that may further include a position determining unit (the superimposing-position determining unit 15) configured to determine a display position of the superimposable image such that the superimposable image and a reference position in the display-target region have a prescribed positional relationship.

According to the above-described configuration, the superimposable image is displayed so as to have a prescribed positional relationship with respect to a reference position in the display-target region. Hence, even in a case where a user specifies any, display-target region, the superimposable image is displayed at a prescribed position on the display screen. Consequently, the viewability of the superimposable image can be improved.

A display control device according to a seventh aspect of the disclosure is the display control device according to any one of the first to fifth aspects that may further include a target detecting unit (13) configured to detect, from the captured image, a detection target being a part of the imaging target that has a prescribed external appearance. In the display control device, in a case where the target detecting unit detects the detection target in the display-target region, the superimposing unit may cause the superimposable image associated with the detection target to be displayed in association with the detection target.

According to the above-described configuration, in a case where a detection target having a prescribed appearance is detected in the display-target region, a superimposable image associated with the detection target is displayed in association with the detection target. Hence, when a detection target having a prescribed appearance enters the display-target region, the user is allowed to recognize multifaceted information on the detection target.

A display control device (the display devices 1 and 30, and the server 40) according to an eighth aspect of the disclosure is a display control device that causes a display device (the display unit 19) to display a partial image of a specified display-target region within an image region of a captured image obtained by capturing an imaging target. The display control device includes: a region identifying unit (the omnidirectional image rendering unit 12) configured to identify the display-target region; and a superimposing unit (the combining unit 16) configured to cause an image to be displayed as being superimposed over the partial image, the image being obtained by capturing at least a part of the imaging target and having a higher resolution than the captured image.

According to the above-described configuration, the display-target region is identified, and an image that is obtained by capturing at least a part of the imaging target and that has a higher resolution than the captured image is displayed as being superimposed over the partial image. As a result, the imaging target can be indicated to the user by means of the partial image, and the imaging target can also be indicated to the user by means of the image superimposed over the partial image. In addition, the image to be superimposed has a higher resolution than the captured image, and thus, according to the image to be superimposed, the imaging target can be displayed in a higher definition than the partial image. Thus, the user is allowed to recognize multifaceted information on the imaging target. To put it differently, the above-described configuration has an effect of improving the display content in a technique for displaying an image as being superimposed over the partial image of the specified display-target region in the image region.

A display control device (the display devices 1 and 30, and the server 40) according to a ninth aspect of the disclosure is a display control device (the display device 1) that causes a display device (the display unit 19) to display a partial image of a specified display-target region within an image region of a captured image obtained by capturing an imaging target. The display control device includes: a position determining unit (superimposing-position determining unit 15) configured to determine, in accordance with a content of the partial image, a superimposing position of a superimposable image to be displayed as being superimposed over the partial image; and a superimposing unit (the combining unit 16) configured to cause the superimposable image to be displayed as being superimposed at the superimposing position determined by the position determining unit (superimposing-position determining unit 15).

According to the above-described configuration, the superimposing position of the superimposable image is determined in accordance with the display content of the display-target region. Thus, the superimposable image can be displayed at a suitable position in accordance with the display content. To put it differently, the above-described configuration has an effect of improving the display content in a technique for displaying an image as being superimposed over the partial image of the specified display-target region in the image region.

A head-mounted display (the display devices 1 and 30) according to a tenth aspect of the disclosure includes: a display control device (the display control unit 11) according to any one of the first to ninth aspects; and a display device (the display unit 19) configured to display an image in accordance with a control performed by the display control device, Hence, the tenth aspect has similar effects to those obtainable by the first to the ninth aspects.

A control method for a display control device (the display devices 1 and 30, and the server 40) according to an eleventh aspect of the disclosure is a control method for a display control device that causes a display device (the display unit 19) to display a partial image of a specified display-target region within an image region of a captured image obtained by capturing an imaging target. The method includes: identifying the display-target region (Steps S1, S11, and S31); and superimposing, to be displayed over the partial image, a superimposable image obtained by capturing at least a part of the imaging target by use of a different imaging device from an imaging device used for capturing the captured image (the Steps S5, S19, and S38). Hence, the eleventh aspect has similar effects to those obtainable by the above-mentioned aspect 1.

A display control device (the display devices 1 and 30, and the server 40) according to each aspect of the disclosure may be implemented by a computer. In this case, a display control program for the display control device (the display device 1) that causes a computer to implement the display control device (the display device 1) by causing a computer to operate as each of the units (software elements) included in the display control device (the display device 1) and a computer-readable recording medium storing the program are included in the scope of the disclosure.

The disclosure is not limited to each of the above-described embodiments. It is possible to make various modifications within the scope of the claims. An embodiment obtained by appropriately combining technical elements each disclosed in different embodiments falls also within the technical scope of the disclosure. Further, when technical elements disclosed in the respective embodiments are combined, it is possible to form a new technical feature.

### CROSS-REFERENCE OF RELATED APPLICATION

This application claims the benefit of priority to JP 2016-231676 filed on Nov. 29, 2016, which is incorporated herein by reference in its entirety.

### REFERENCE SIGNS LIST

1 Display device (display control device)
12 Omnidirectional image rendering unit (region identifying unit)
13 Target detecting unit (prohibited-object detecting unit, target detecting unit)
15 Superimposing-position determining unit (prohibited-region identifying unit, position determining unit)
16 Combining unit (superimposing unit)
19 Display unit (display device)
40 Server (display control device)

1. A display control device that causes a display device to display a partial image of a specified display-target region within an image region of a captured image obtained by capturing an imaging target, the display control device comprising:
a region identifying unit configured to identify the display-target region; and
a superimposing unit configured to cause a superimposable image to be displayed as being superimposed over the partial image, the superimposable image being obtained by capturing at least a part of the imaging target by use of a different imaging device from an imaging device used for capturing the captured image.

2. The display control device according to claim 1 further comprising:
a position determining unit configured to determine a superimposing position at which the superimposable image is to be superimposed in accordance with a content of the partial image.

3. The display control device according to claim 2,
wherein in a case where a prescribed region of the captured image is included in the display-target region, the position determining unit determines to cause a display position of the superimposable image to be within the prescribed region.

4. The display control device according to claim 2 further comprising:
a prohibited-region identifying unit configured to identify, within the display-target region, a superimposition-prohibited region over which the superimposable image is not allowed to be superimposed,
wherein the position determining unit defines a display position of the superimposable image outside of the superimposition-prohibited region identified by the prohibited-region identifying unit.

5. The display control device according to claim 4 further comprising:
a prohibited-object detecting unit configured to detect a superimposition-prohibited object from the captured image, the superimposition-prohibited object being a part of the imaging target over which the superimposable image is not allowed to be superimposed,
wherein in a case where the prohibited-object detecting unit detects the superimposition-prohibited object in the display-target region, the prohibited-region identifying unit identifies the superimposition-prohibited region that includes the superimposition-prohibited object.

6. The display control device according to claim 1 further comprising:
a position determining unit configured to determine a display position of the superimposable image such that the superimposable image and a reference position in the display-target region have a prescribed positional relationship.

7. The display control device according to claim 1 further comprising:
a target detecting unit configured to detect, from the captured image, a detection target, the detection target being a part of the imaging target that has a prescribed external appearance,
wherein in a case where the target detecting unit detects the detection target in the display-target region, the superimposing unit causes the superimposable image associated with the detection target to be displayed in association with the detection target.

8. A display control device that causes a display device to display a partial image of a specified display-target region within an image region of a captured image obtained by capturing an imaging target, the display control device comprising:
a region identifying unit configured to identify the display-target region; and
a superimposing unit configured to cause an image to be displayed as being superimposed over the partial image, the image being obtained by capturing at least a part of the imaging target and having a higher resolution than the captured image.

9. A display control device that causes a display device to display a partial image of a specified display-target region within an image region of a captured image obtained by capturing an imaging target, the display control device comprising:
a position determining unit configured to determine, in accordance with a content of the partial image, a superimposing position of a superimposable image to be displayed as being superimposed over the partial image; and
a superimposing unit configured to cause the superimposable image to be displayed as being superimposed at the superimposing position determined by the position determining unit.

10. A head-mounted display comprising:
a display control device according to claim 1; and
a display device configured to display an image in accordance with a control performed by the display control device.

11. (canceled)

12. A control program that causes a computer to function as a display control device according to claim 1,
wherein the control program causes the computer to function as the region identifying unit and the superimposing unit.

13. A control program that causes a computer to function as a display control device according to claim 9,
wherein the control program causes a computer to function as the position determining unit and the superimposing unit.
